(19) United States
(12) Patent Application Publication
(10) Pub. No.: US 2009/0166555 A1
(43) Pub. Date: Jul. 2, 2009

(54) RF electron source for ionizing gas clusters

(76) Inventors: Joseph C. Olson, Beverly, MA (US); Jay T. Scheuer, Rowley, MA (US)

Correspondence Address: Nields, Lemack & Frame, LLC, 176 E. MAIN STREET, SUITE 5, WESTBOROUGH, MA, 01581, US

(21) Appl. No.: 12/005,757

(22) Filed: Dec. 28, 2007

(51) Int. Cl. H01J 27/00

(52) U.S. Cl. 250/427

(57) ABSTRACT

The present invention discloses a system and method for generating gas cluster ion beams (GCIB) having very low metallic contaminants. Gas cluster ion beam systems are plagued by high metallic contamination, thereby affecting their utility in many applications. This contamination is caused by the use of thermionic sources, which impart contaminants and are also susceptible to short lifecycles due to their elevated operating temperatures. While earlier modifications have focused on isolating the filament from the source gas cluster as much as possible, the present invention represents a significant advancement by eliminating the thermionic source completely. In the preferred embodiment, an inductively coupled plasma and ionization region replaces the thermionic source and ionizer of the prior art. Through the use of RF or microwave frequency electromagnetic waves, plasma can be created in the absence of a filament, thereby eliminating a major contributor of metallic contaminants.

### BACKGROUND OF THE INVENTION

Ion implanters are commonly used in the production of semiconductor wafers. An ion source is used to create a beam of positively charged ions, which is then directed toward the wafer. As the ions strike the workpiece, they change the properties of the workpiece in the area of impact. This change allows that particular region of the workpiece to be properly “doped”. The configuration of doped regions defines their functionality, and through the use of conductive interconnects, these wafers can be transformed into complex circuits.

There is also a need for surface treatments, such as etching, smoothing and cleaning. These treatments, as well as shallow doping, require a different implantation process, which utilizes low-energy ions. To address this, gas cluster ion beams (GCIB) are used to perform these functions.

FIG. 1 shows a traditional gas cluster ion implantation system 100. The system 100 is typically enclosed in a vacuum housing (not shown). A source gas is introduced into the vacuum housing via an appropriately shaped nozzle 102. Suitable gases include, but are not limited to, inert gases (such as argon), oxygen-containing gases (such as oxygen and carbon dioxide), nitrogen containing gases (such as nitrogen or nitrogen triflouride), and other dopant-containing gases (such as diborane). The nozzle 102 injects the source gas at high speed, such as supersonic speed. Since the vacuum chamber is at a much lower pressure than the source gas, the injected gas experiences an instantaneous expansion that results in the cooling and condensation of the injected gas. In other words, the injected source gas will condense into a jet 10 of gas clusters wherein each gas cluster contains between a few and several thousand atoms or molecules. The cluster jet 10 then passes through a skimmer 104 that removes stray atoms or molecules that have not condensed into clusters from the cluster jet 10. The resulting cluster jet 12 is then ionized in an ionizer 106.

The ionizer 106 typically produces thermionically emitted electrons and causes them to collide with the gas clusters in the cluster jet 12, thereby ionizing the gas clusters to form a gas cluster ion beam 14. These collisions eject electrons from the cluster, causing the cluster to become positively charged.

FIG. 2 shows a cross section of a traditional ionizer 200 used in the prior art. The gas cluster enters the ionizer 200 in a direction perpendicular to the cross section of the ionizer, as shown by directional arrow 201. One or more thermionic sources 210 generate electrons. These electrons are directed toward the gas cluster due to electron repeller electrodes 220. Electron repeller electrodes are negatively biased with respect to the thermionic filaments, causing the electrons to be repelled toward the gas cluster. Beam forcing electrodes 230 are positively biased with respect to the thermionic filaments, attracting the electrons and causing them to strike the electrode 230 and produce low energy secondary electrons. Insulators 240 maintain isolation between the various electrodes in the ionizer.

The thermionic source 210 is typically a thermionic filament, preferably made from tungsten. In many cases, the tungsten filament is held in place with molybdenum clasps, due to molybdenum's high melting point and its ability to retain its shape at high temperature.

Referring to FIG. 1, the gas cluster ion beam 14 preferably passes through one or more sets of electrodes 108 that focus the ion beam and/or accelerate it to the desired energy level. The gas cluster ion beam 14 is optionally filtered through a mass analyzer 110 that selects the gas molecules of desired mass. For example, the mass analyzer 110 may deflect all monomer ions and allow only more massive ions to pass through. Finally, the gas cluster ion beam 14 is directed toward a wafer (not shown) that is typically housed in an end station. The wafer can be mechanically scanned and/or tilted during the implantation with the gas cluster ion beam 14. A neutralizer 112 is used to maintain charge neutrality to offset charge buildup on the wafer. The use of gas cluster ion beams enables implantations at a depth of 5-100 angstroms.

However, gas cluster ion implanters are not without significant drawbacks. For example, the source gases may be highly corrosive, such as nitrogen triflouride. Such gases attack the thermionic source, thereby shortening the filament's life and contaminating the gas cluster.

Metallic contamination is a major issue for these traditional gas cluster ion beam implanters. Several of the greatest contaminants are tungsten, molybdenum and chromium. These three metals are found in the thermionic source, either as part of the filament, or as part of the associated structure supporting the filament or within the ionizer.

To reduce the contamination associated with gas cluster ion beam implantation, several changes to the traditional system have been disclosed. In one embodiment, the electron repeller and beam forming electrodes of FIG. 2 are replaced by graphite rods.

A further reduction in contaminants is achieved in the prior art by attempting to separate the thermionic source from the ionizer. In this embodiment, a plasma source, which contains a filament, is used to supply the required electrons. Plasma is created by injecting noble gas into the plasma chamber. However, the electrons are still created by a thermionic source. The electrons are then directed to and through small apertures in the plasma chamber by a set of electrodes. The pressure within the plasma chamber is higher than that within the ionizer, which attempts to minimize the flow of gas molecules from the gas clusters into the plasma chamber. Since little gas enters the chamber, the amount of corrosion of the filament is reduced.

This ionizer results in contaminants of less than 10×10¹⁰ ions per square centimeter. While this represents an improvement from the embodiment of FIG. 1 (which measured 4000×10¹⁰ ions per square centimeter), this number is still significantly higher than contamination numbers seen with traditional ion beam implantation, which are on the order of less than 1×10¹⁰ ions per square centimeter. Furthermore, the filaments typically have a short lifespan due to their elevated operating temperatures.

Thus, to achieve contaminant concentrations similar to those of conventional ion beam implantation, a better system and method of creating gas cluster ion beams is desirous.

### SUMMARY OF THE INVENTION

The problems of the prior art are overcome by the present invention, which discloses a system and method for generating gas cluster ion beams (GCIB) having very low metallic contaminants. As described above, gas cluster ion beam systems are plagued by high metallic contamination, thereby affecting their utility in many applications. This contamination is caused by the use of thermionic sources, which impart contaminants and are also susceptible to short lifecycles due to their elevated operating temperatures. While earlier modifications have focused on isolating the filament from the source gas cluster as much as possible, the present invention represents a significant advancement by eliminating the thermionic source completely.

In the preferred embodiment, an inductively coupled plasma and ionization region replaces the thermionic source and ionizer of the prior art. Through the use of RF or microwave frequency electromagnetic waves, plasma can be created in the absence of a filament, thereby eliminating a major contributor of metallic contaminants. The electrons generated by the plasma then enter the ionization region, where they collide with the gas clusters, thereby producing gas cluster ion beams.

### BRIEF DESCRIPTION OF THE DRAWINGS

FIG. 1 shows a representative gas cluster ion beam system of the prior art;

FIG. 2 shows a cross section of a representative ionizer for the system of FIG. 1;

FIG. 3 shows an inductively coupled electromagnetic electron source for use with the present invention;

FIGS. 4a-d shows various embodiments of the aperture plate of a plasma chamber for use with the present invention;

FIG. 5 shows a first embodiment of the present invention; and

FIG. 6 shows a second embodiment of the present invention.

### DETAILED DESCRIPTION OF THE INVENTION

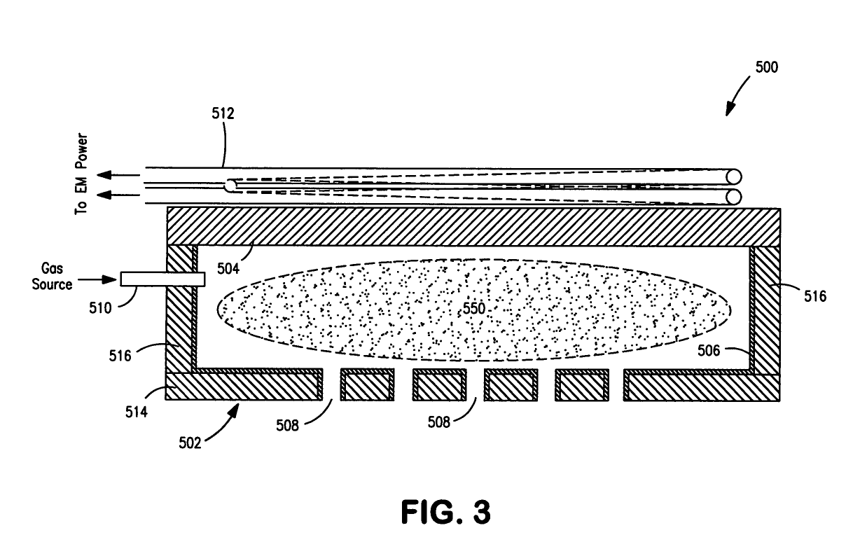

FIG. 3 illustrates an inductively coupled electromagnetic electron source for use with the present invention. Such an electron source is disclosed in copending U.S. patent application Ser. No. 11/376,850, which is hereby incorporated by reference.

The inductively coupled electromagnetic electron source 500 comprises a plasma chamber 502 that preferably has a metal free inner surface. In the preferred embodiment, no metal components are within the plasma chamber 502. However, other embodiments may tolerate the use of metallic components within the chamber. Plasma chamber 502 comprises sidewalls 516, dielectric plate 504 and aperture plate 514. In one embodiment, the sidewalls 516 and aperture plate 514 are constructed from a non-metallic material, such as graphite or silicone carbide. In another embodiment, the inner surface of the plasma chamber 502 has a coating 506 comprising a non-metallic material, such as graphite or silicon carbide. In such an embodiment, the sidewalls may be constructed from a non-metallic or a metallic material.

The dielectric plate 504 comprises a dielectric material so as to allow energy from coil 512 to permeate into the plasma chamber 502. In a preferred embodiment, a dielectric containing no metallic components, such as quartz, is used. In another embodiment, a dielectric containing metal, such as aluminum oxide, can be used.

Gas is injected into the plasma chamber 502 via gas inlet 510. Through this inlet 510, one or more gaseous substances can be supplied to the plasma chamber 502. In one embodiment, inert gases, such as argon (Ar), xenon (Xe) or helium (He) are used. The gas pressure is typically maintained at 1-50 mTorr.

Coil 512 is placed above dielectric plate 504. The coil 512 preferably has an elongated planar shape that extends along the length of the dielectric plate 504. The coil 512 is connected to an electromagnetic (EM) power supply (not shown) and inductively couples EM electrical power through dielectric plate 504 and into plasma chamber 502. The EM power supply preferably operates at frequencies typically allocated to industrial, scientific and medical (ISM) equipment, such as 2, 13.56 and 27.12 MHz. One of ordinary skill in the art will appreciate that although several frequencies are listed, the invention is not so limited and the EM power supply may operate at any suitable frequency. The term electromagnetic power is intended to encompass all frequency spectrums that are suitable for this application, including but not limited to radio frequency (RF) and microwave.

The EM electrical power inductively coupled into the plasma chamber 502 excites the gases within to create plasma 550. The shape and position of the plasma 550 within the chamber 502 may be affected at least in part by the position and shape of coil 512. According to some embodiments, the coil extends substantially the whole length and width of the chamber 502. Due to the metal-free inner surface, no metallic contaminants are added to the plasma 10.

To allow charged particles (i.e. electrons and ions) to exit the plasma chamber 502, aperture plate 514 has one or more apertures 508. These apertures can vary in size and shape, so long as they are suitable for the passage of electrons.

In one embodiment, magnetic fields can be created within the plasma chamber 502 to further promote the passage of electrons and confine the plasma within the plasma chamber 502.

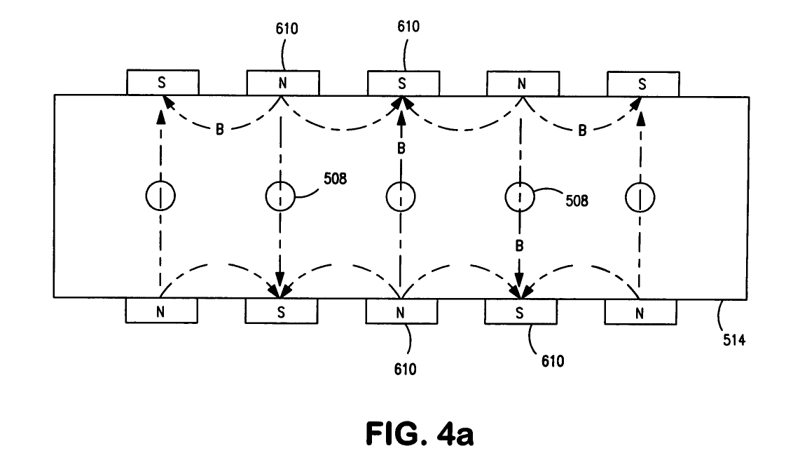

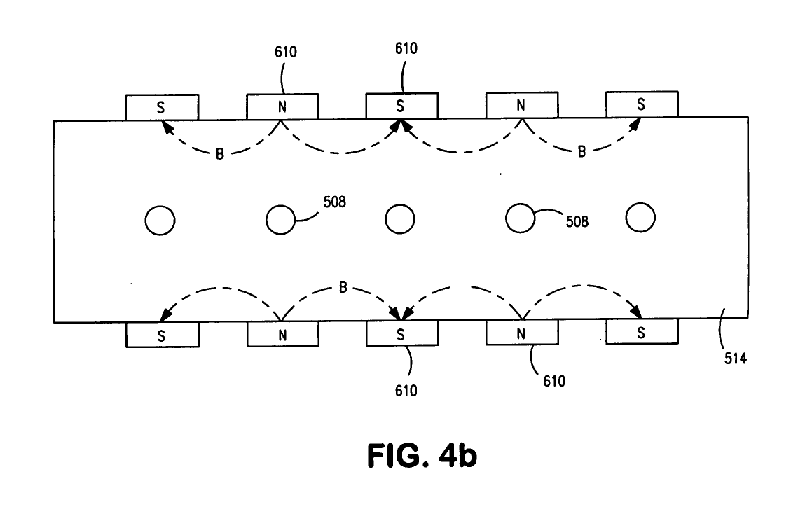

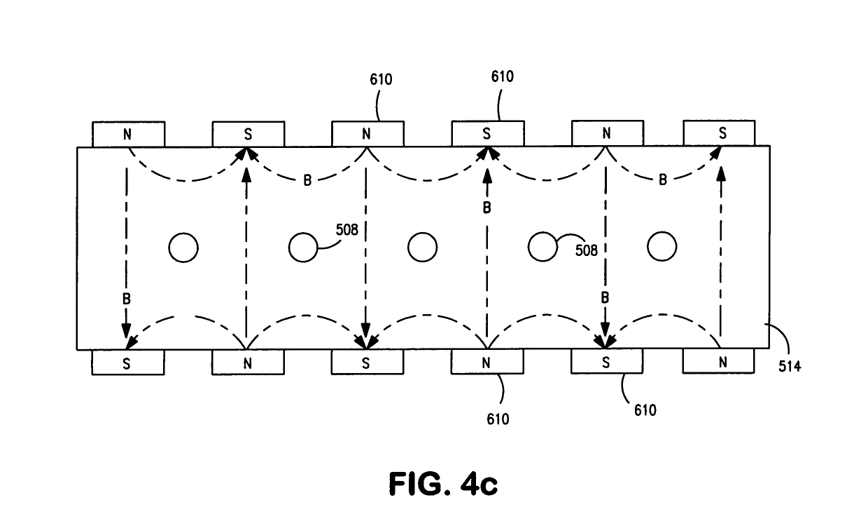

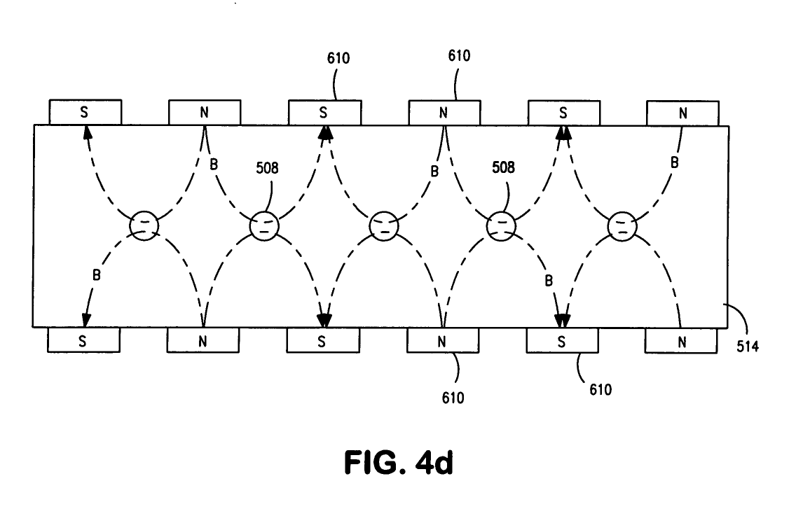

FIG. 4a shows one configuration of magnets and the fields created by these magnets. Aperture plate 514 has one or more exit apertures 508. In this embodiment, permanent magnets 610 are placed along the sidewalls of the plasma chamber. The magnets are placed, alternating north poles and south poles, and with opposite poles opposite each other. In this embodiment, the magnets are aligned with the apertures 508. This configuration creates cusps and dipoles in the magnetic field. The cusps serve to confine the plasma lengthwise within the plasma chamber and the magnetic dipoles serve to filter out high-energy electrons.

In an alternate embodiment, the magnets are placed, alternating north poles and south poles, and the like pole opposite each other, as shown in FIG. 4b. The magnets are aligned with the apertures, as is shown in FIG. 4a. Such a configuration creates magnetic cusps as described above. However, no dipoles are created.

In another embodiment, the magnets are placed in a configuration similar to that shown in FIG. 4c. In this instance, the magnets are not aligned with the apertures. Both cusps and dipoles are created as shown in the Figure.

In another embodiment, the magnets are placed, alternating north poles and south poles, and the like pole opposite each other, as shown in FIG. 4d. However, the magnets are not aligned with the apertures.

Other embodiments and configurations of magnets are possible. By varying the magnetic field, the uniformity and density of the plasma can be adjusted. The recitation of these embodiments is for illustrative purposes only and is not meant to limit the invention to only these configurations. Furthermore, there is no requirement that a magnetic field be created within the plasma chamber 502 for the present invention.

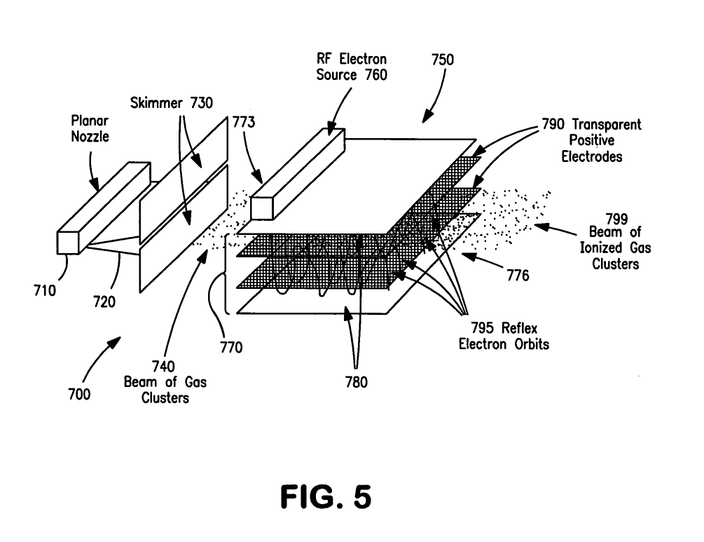

FIG. 5 shows a first embodiment of the present invention. Although not shown, the system 700 is typically enclosed in a vacuum housing. A source gas is introduced into the vacuum housing via an appropriately shaped nozzle 710. Suitable gases include, but are not limited to, inert gases (such as argon), oxygen-containing gases (such as oxygen and carbon dioxide), nitrogen containing gases (such as nitrogen or nitrogen triflouride), and other dopant-containing gases (such as diborane). The nozzle 710 injects the source gas at high speed, such as supersonic speed. Since the vacuum chamber is at a much lower pressure than the source gas, the injected gas experiences an instantaneous expansion that results in the cooling and condensation of the injected gas. In other words, the injected source gas will condense into a jet 720 of gas clusters wherein each gas cluster contains between a few and several thousand atoms or molecules. In one embodiment, a planar nozzle as shown in FIG. 5 is used to inject a broader planar cluster. In a second embodiment, a nozzle suitable for injecting a spot cluster is used. In both embodiments, the cluster jet 720 then passes through a skimmer 730 that removes stray atoms or molecules that have not condensed into clusters from the cluster jet 720. The resulting cluster jet 740 is then ionized in an ionizer 750.

The ionizer 750 of the present invention comprises an electron source 760 and an ionization region 770. The electron source 760 is an inductively coupled electromagnetic electron source, as described in conjunction with FIG. 3. The aperture plate of the inductively coupled EM electron source 760 is in close communication with the ionization region 770, such that electrons leaving the plasma chamber enter the ionization region 770.

The ionization region 770 is the region where electrons interact with the gas clusters, and is partially defined by inlet 773 and outlet 776. Cluster jet 740 enters the ionization region 770 via inlet 773. To facilitate collisions between the electrons and the gas clusters, electrodes can be added to the ionization region 770. In one embodiment, the outer walls 780 of the ionization region 770 are negatively biased, so as to repel electrodes. As electrons from the electron source 760 enter the ionization region, they are repelled from the outer walls 780 toward the gas clusters. One or more positively biased electrodes 790 can be inserted between the negatively biased outer walls 780. The electrodes 790 and outer walls 780 are preferably constructed from graphite or other suitable nonmetal materials. This configuration causes the electrons to accelerate to modest energy and travel to and through the positive electrodes 790. As they approach the negatively biased walls 780, they are reflected back into the beam. This configuration increases the number of interactions between the gas cluster and the electrons in order to improve the fraction of clusters ionized. Orbits 795 represent exemplary lines of travels for electrons in this configuration.

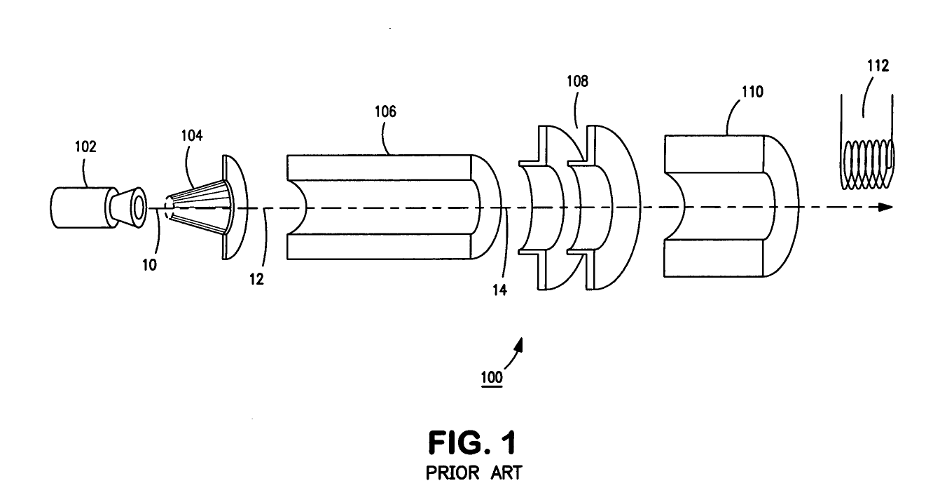

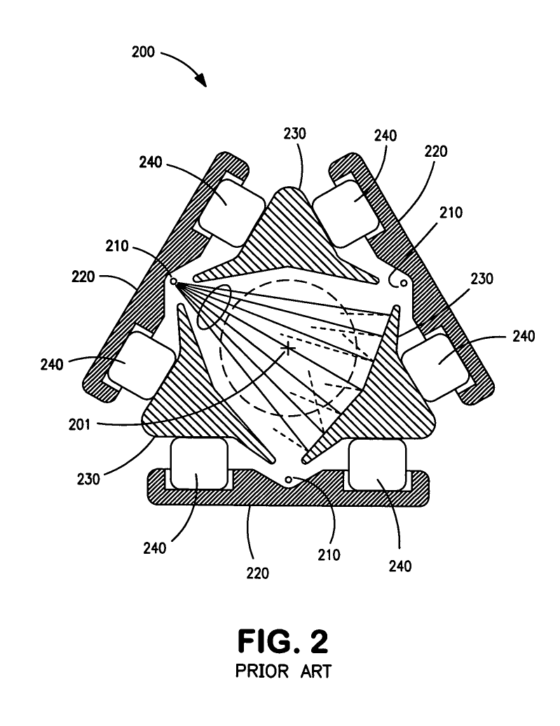

The gas cluster beam 799 then exits the ionization region via outlet 776, having been ionized by the electrons. The remaining portions of the system may be similar to those described in connection with FIG. 1. Note that the ionizer contained no metallic components, thereby eliminating any potential source of contamination.

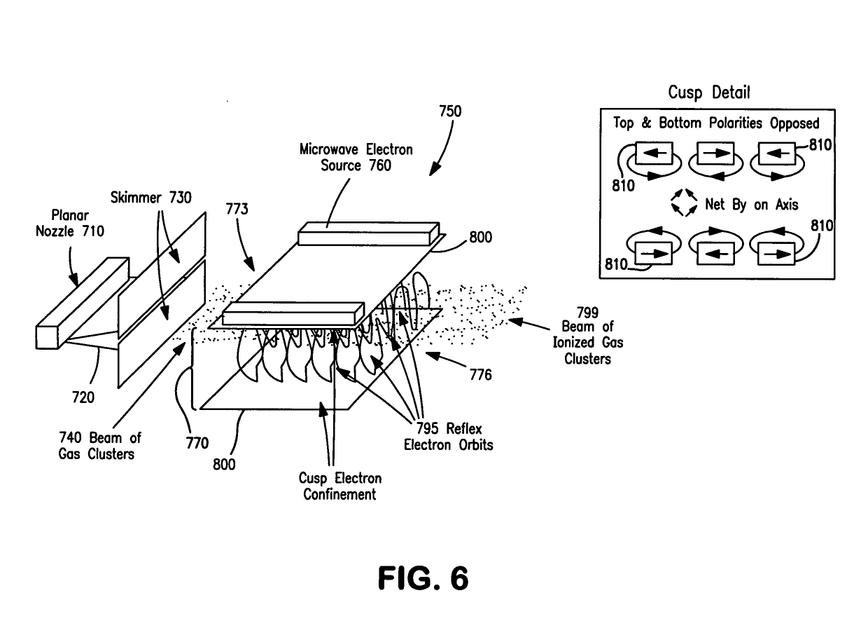

FIG. 6 represents a second embodiment of the present invention. In this embodiment, rather than negatively biased outer walls and positively biased electrodes, magnets are used to contain and deflect the electrons in the ionization region 770. The insert in FIG. 6 shows a configuration of magnets 810. The magnets 810 are placed on or near the outer walls 800, in an arrangement such as that shown in the insert. The magnets 810 are configured so that opposite poles are aligned across the ionization region 770, and like poles abut each other. This creates a cusp pattern that confines the electrons and causes them to move between the upper and lower outer walls 800 of the ionization region 770. Orbits 795 represent exemplary lines of travels for electrons in this configuration.

Other configurations of magnets are also possible and within the scope of the present invention. One of ordinary skill in the art will appreciate that by varying the pole orientation, the magnetic field can be adjusted, thereby affecting the travel paths of the electrons.

As described with reference to FIG. 5, the gas cluster enters the ionization region 770 having passed though the skimmer. After it exits the ionization region 770, it has been transformed into a gas cluster ion beam 799. This beam is substantially free of contaminants, due to the complete absence of metallic components in the ionizer.

In summary, as described above, traditional gas cluster ion beam systems are plagued by high metallic contamination, thereby affecting their utility in many applications. This contamination is caused by the use of thermionic sources, which impart contaminants and are also susceptible to short lifecycles due to their elevated operating temperatures. While earlier modifications have focused on isolating the filament from the source gas cluster as much as possible, the present invention represents a significant advancement by eliminating the thermionic source completely. Furthermore, by eliminating the need for a thermionic source, the lifespan and reliability of the ionizer is significantly increases over the prior art.

While this invention has been described in conjunction with the specific embodiments disclosed above, it is obvious to one of ordinary skill in the art that many variations and modifications are possible. Accordingly, the embodiments presented in this disclosure are intended to be illustrative and not limiting. Various embodiments can be envisioned without departing from the spirit of the invention.

What is claimed:

1. An ionizer for forming a gas cluster ion beam, comprising:
a. an inlet through which a gas cluster is injected into an ionization region;
b. an inductively coupled electromagnetic electron source for providing electrons into said ionization region;
c. an outlet through which said gas cluster ion beam passes; and
d. said ionization region, partially defined by said inlet and said outlet, wherein said electrons ionize a portion of said gas cluster to form said gas cluster ion beam.

2. The ionizer of claim 1, wherein said ionization region comprising outer walls that are negatively biased so as to repel said electrons toward said gas cluster.

3. The ionizer of claim 2, wherein said ionization region further comprises at least one positively biased electrode, located between said outer walls.

4. The ionizer of claim 3, wherein said outer walls and said electrode comprise a non-metallic material.

5. The ionizer of claim 4, wherein said outer walls and said electrode comprise graphite.

6. The ionizer of claim 1, wherein said inductively coupled electromagnetic electron source comprises a plasma chamber having at least one aperture in communication with said ionization region, a gas inlet in communication with said plasma chamber, and a electromagnetic power source.

7. The ionizer of claim 6, wherein said electromagnetic power source is coupled to said plasma chamber via a dielectric plate.

8. The ionizer of claim 7, wherein said electromagnetic power source comprises an energizing coil in communication with said dielectric plate.

9. The ionizer of claim 6, wherein said plasma chamber comprises magnets positioned outside the walls of said chamber for providing a magnetic field to confine the plasma produced by said gas and said electromagnetic power.

10. The ionizer of claim 9, wherein said magnetic field generates magnetic cusps.

11. The ionizer of claim 9, wherein said magnetic field generates magnetic dipoles.

12. The ionizer of claim 1, wherein said ionization region comprises magnets positioned outside the walls of said region for providing a magnetic field within said ionization region.

13. The ionizer of claim 12, wherein said magnetic field generates magnetic cusps.

14. A process for creating a gas cluster ion beam, comprising:
a. injecting gas clusters into an ionization region;
b. using electromagnetic energy to generate a plasma; and
c. directing electrons from said plasma to said ionization region, where they ionize said gas clusters.

15. The process of claim 14, further comprising:
a. providing a plasma chamber having a gas inlet, and a dielectric plate, and a coil, outside of said plasma chamber, in communication with said dielectric plate; and an electromagnetic power supply;
b. injecting a source gas into said chamber via said inlet; and
c. energizing said coil with said power supply.

16. The process of claim 14, wherein said ionization region comprises outer walls, and further comprising negatively biasing said outer walls.

17. The process of claim 14, further comprising:
a. providing at least one positively biased electrode within said ionization region to accelerate said electrons.

18. The process of claim 14, further comprising:
a. providing a magnetic field within said ionization region so as to confine and accelerate said electrons within said region.
